(19) United States
(12) Patent Application Publication
(10) Pub. No.: US 2012/0169737 A1
(43) Pub. Date: Jul. 5, 2012

(54) Unified system for articulating 3 dimensional animated character and creature models in computer graphics animation

(76) Inventor: Joseph Alter, (US)

(21) Appl. No.: 13/374,310

(22) Filed: Dec. 19, 2011

(51) Int. Cl. G06T 17/00

(52) U.S. Cl. 345/428

(57) ABSTRACT

Improved methods for creating highly detailed articulation of animated characters and creatures in computer graphics and animation and improved methods for pose space deformation of same.

### FIELD OF INVENTION

Computer animation has been around [in practice] since the early 80's. Much effort has gone into creating tools that can use it to animate characters and has become, possibly, the largest economic segment of the computer graphics industry. Certain breakthrough films that occurred in the middle 80's [“Tony de Peltrie”—Bergeron, Lachapelle, Langlois, Robidoux et al] created with them a set of tools that was to define how characters would be animated and articulated in the field of computer graphics and animation for decades to come.

### OVERVIEW

We know now how to quite efficiently animate the pantomime of computer graphics characters, largely using the techniques pioneered in the 80's. These innovations transformed the industry from computer scientists creating animation, to animators creating animation—a production approach that Pixar pioneered in the few years to follow. Computer graphics character animation is such an accepted practice that it can now be taught to art students with no technical background whatsoever.

There have been certain intractable problems surrounding computer graphics character animation in the form of gaps in capability—relegating certain aspects again still to computer scientists with some artistic capabilities—these are generally known as TD's [technical directors] in the computer graphics industry.

Until recently, creating highly detailed models in an interactive process really did not exist. People would create a low polygon version of their model, the resolution would get multiplied inside the render, and then maps to displace the surface would be applied to articulate high resolution detail. This is a very indirect form of control, and would again relegate the combining of those elements to a TD, again separating the artist who sculpts the model, from the artist who paints that mapped detail. Recent programs, pioneered largely by Pixologic's ZBrush. This helped close the gap between modeler [the guy who creates the model] and articulator/texture artist and has lead to a real renaissance in digital sculpting.

There are still many gaps in this capability surrounding the connection of high resolution detail, animation and rendering. This invention relates to computer methods that can apply sculpted corrections to problematic animation using multi-resolution modeling techniques. It also relates to methods that improve the state of the art for mixing said corrections together into a renderable model via an improved method of “pose spaced deformation”

### PRIOR ART

### Patents

U.S. Pat. No. 7,333,112 Andersen Et al “Rig Baking”

U.S. Pat. No. 5,883,638 “Method and Apparatus for Creating Lifelike Digital Representations of Computer Animated Objects by Providing Corrective Enveloping”

U.S. Pat. No. 7,817,159 Schuster et al “Digital Painting”

U.S. Pat. No. 7,652,675 Jerome Maillot “Dynamically adjusted brush for direct paint system on parameterized multi-dimensional surfaces”

U.S. Pat. No. 6,720,962 “Method and apparatus for three-dimensional painting”

U.S. Pat. No. 6,239,807 “Method and system for multi-resolution texture mapping”

### PAPERS

Lewis J. P. et al : “Pose Space Deformation: A Unified Approach to Shape Interpolation and Skeleton-Driven Deformation”

Simon Clutterbuck et al: “A Physically based Approach to Virtual Character Deformations”

Juban Dave et al: “The Chronicles of Naria:The Lion, The Crowds and Rhythm and Hues”

### SPECIFICATION

A large gap still exists at the nexus of animation and high-res articulation. Largely because these high resolution sculpts that people create usually get ‘baked’ into maps so they can be applied inside the render just like they have been for 20 years. But that's not the only gap, also animating the low resolution figure tends to twist it up in ways that are clearly problematic. The preferred embodiment makes use of a number of methods to help correct that, such as Pose Space Deformation [JP Lewis et al].

Pose Space Deformation gets its name because an imaginary space (coordinate system) is created where a character's animated position is represented by a cluster of points in pose space and a distance may be measured between that cluster and the ones in each of a stored set of library poses, this creating a ‘strength’ for each of the library shapes. These strengths are then used to mix in the positions of all the surface vertices in the stored object associated with the pose space cluster of points.

However, this method is missing many pieces to make it usable by an artist, and it also does not address the animation of the higher resolution detail that rides on top of it.

Normally, the animation of articulated figures consists of a low resolution model that is in the rest pose (usually a “T”), which is articulated by a skeleton of joints who have weights assigned to them to determine how much of each particular joint's motion a vertex gets. Then keyframe animation is performed on the joints and the skin follows. Users can only modify the geometry in the rest or “T” pose, then those changes get pushed around into the character's current pose. This makes correcting the problems that occur in an animated pose very challenging.

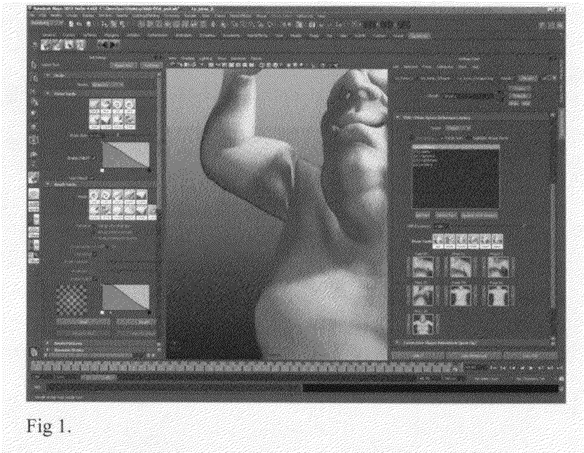

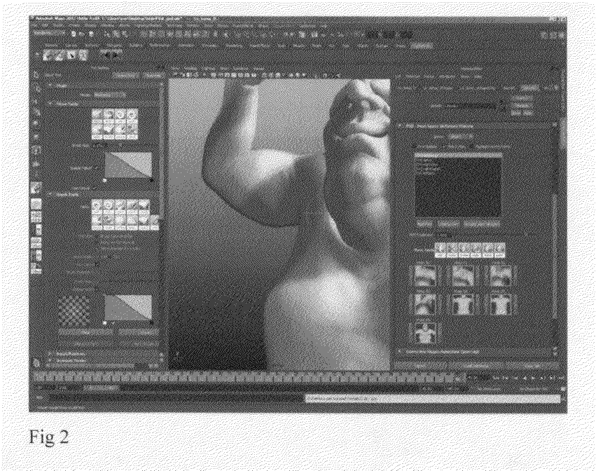

Our Pose Space Deformation [PSD] system in the embodyment, allows you to apply ‘tweaks’ to the low res model in world or object space in its animated position as it gets twisted up by the animation rigging process in a particular scene [FIG. 1], it then builds up a library of these tweaks [FIG. 2] and tries to mix them in where appropriate in the future by measuring joint angles to recognize similarity particular pose and mix in the appropriate amount of tweak from that target based on the strength of the recognition of the pose.

An improvement over the current state of the art which requires all kinds of inversion of joints to the neutral pose to encode the tweaked model so the changes can be animated in neutral space and inverted back. Alternatively the method in the embodyment creates a tangent space on the surface and expresses positions realative to the surface in this tangent space. This eliminates the computationally expensive and infexible method of reversing all the rigging and allows for other types of rigging underneath such as physical muscle simulation.

The present embodiment creates a Pose Space Deformation system and integrates it directly into the animation process and applies multi resolution sculpting techniques to the articulation, however it also creates several improvements to the concept of PSD.

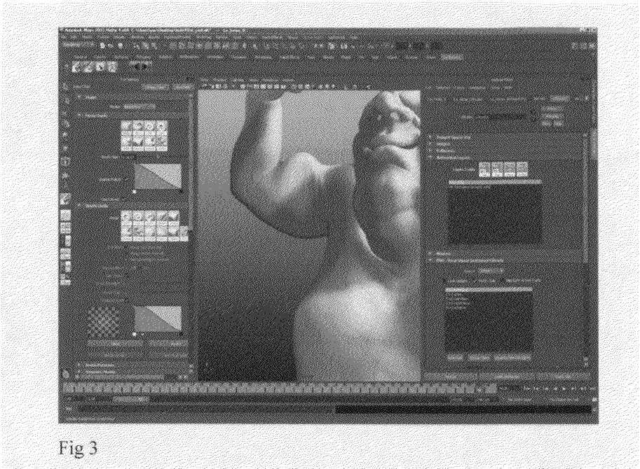

In the preferred embodiment, a product called ‘LipService’, the artist ‘scrubs’ [an animators term for moving around the time slider] around in a scene, viewing the character's articulation at whatever resolution is practical to display in real time, picking a particular pose or frame of animation that is problematic, then hitting a ‘sculpt brush’—this then up-rezes the model to the full render resolution and allows you to sculpt it in position with multi-res sculpting tools. [FIG. 3]

This is something that you cannot do in any unified way in prior art. First of all, when one sculpts currently, one usually sculpts in the rest position of the model. PSD, as already practiced, allows you to modify the object as posed—however you lose all the abilities to sculpt at full resolution. This creates a large gap in the process that again frustrates artists and causes them to take easier ways out, or at large studios who have teams of computer scientists with some art background known as ‘rigging TDs’ that can push these elements together through a variety of non-standard methods.

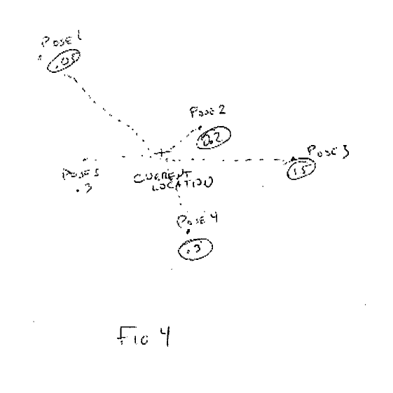

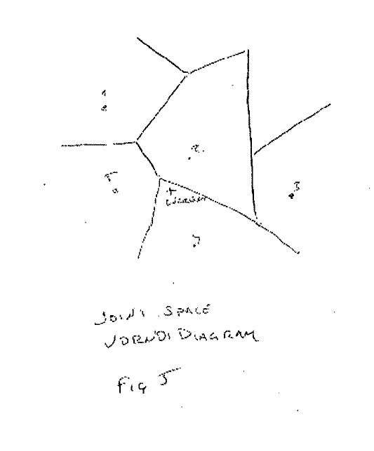

In the preferred embodiment, we also solve many issues that remained unresolved (and therefore not very usable) with PSD. For one thing, PSD articulations typically considered the entire character's pose all at once. This is a lot of joints, typically a 200 or so. It would then create a coordinate space out of the joint angle sets in the poses that the user has stored and try to recognize the animation's current frame's similarity to the poses navigating that coordinate space with a range biased function* [FIG. 4], or solved the that location as a vornoi diagram* [FIG. 5] or some such equivalent. This looks like Magic on paper, but in practice you run into issues like some of the joints aren't moving much, but their positions get equally factored into the selection or weighting of a pose, leading to a lot of incorrect locations within that space, however it's tallied by a normalized consensus of all the poses weights, so what you end up with is not just one pose weight that wrong, but a large number of them—and you get an averaged result that just makes little sense to the artist. This is typically why demonstrations of PSD were usually with just a few joints on, say an arm.

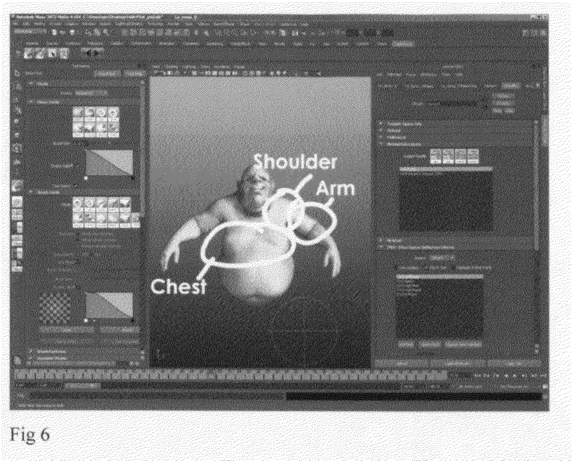

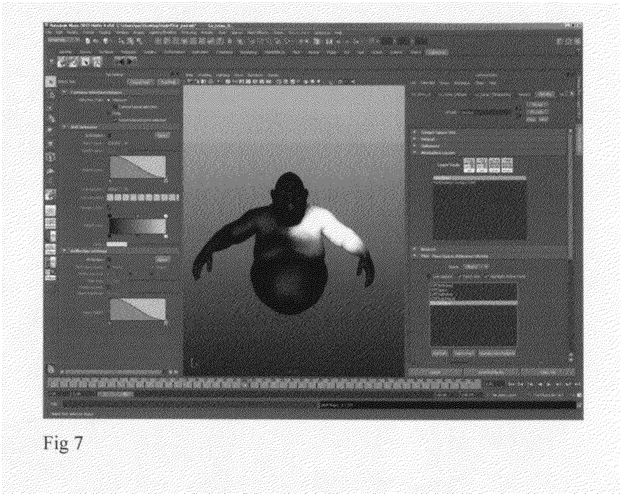

Another improvement we have done in the preferred embodiment is to allow the user to segment the rig [FIG. 6] [or set of bones really] into ‘parts’. For example, one ‘part’ may be the upper and lower arm, another ‘part’ may be the ‘scapula’, ‘shoulder’ and ‘collarbone’. Another one might be the ‘chest and upper spine’. We provide paint tools so the influence of these ‘parts’ can be painted in a natural way with falloff [FIG. 7]. We also internally normalize these falloffs together so we can be sure that they never add up to more than 1. This by itself, already -greatly- improved the PSD engines ability to find the right poses since it calculated the parts separately and then combined the blends inside those masks, but still people complained that it wasn't always right and they had to do things like remove bones from their lists.

This lead to our another improvement, which is—for each part, figure out how active that part is if you were to compare all the stored poses, and assign a bias weight to that joint to emphasize or diminish it's importance. So when all the PSD weights are mixed together, the priority is paid to the bones that are moving the most. Other importance schemes are possible such as attributing greater importance to roll (twisting) than to pitch and yaw, since this kind of motion will usually cause more deformation.

This pretty much locked in our solver, such that the PSD is almost never far off.

Another improvement is the integrated multi-resolution sculpting of the animated shapes. Every time you save an articulated pose, you have all the detail you want in there and that detail gets mixed in as the PSD moves around. It provides WYSWYG relationship to the correction process of high resolution detail, but also allows you to animate it. This also closes gaps between animation of that detail and the render. Previous solutions required the separation of that detail into maps which would get blended in and out and complicated ‘glue’ software between the animation software and the render. There are hundreds of commercial renders out there, so writing glue like this for all of them could never happen. This unified approach eliminates that need making it a solution for everyone in the industry, not just users of a particular combination of software.

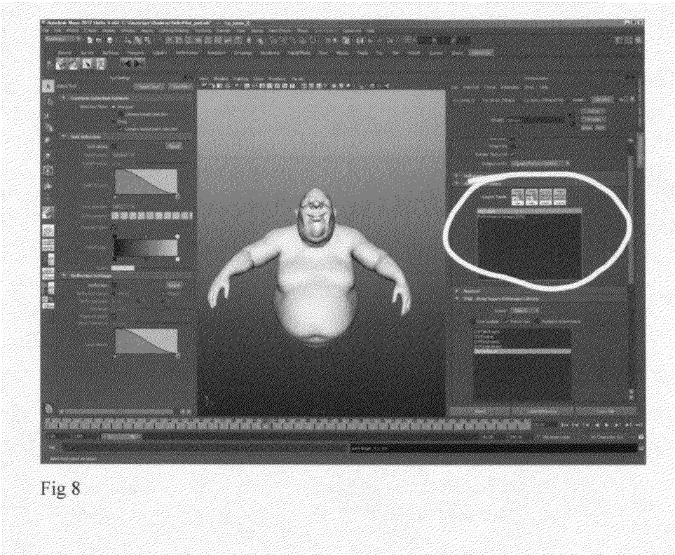

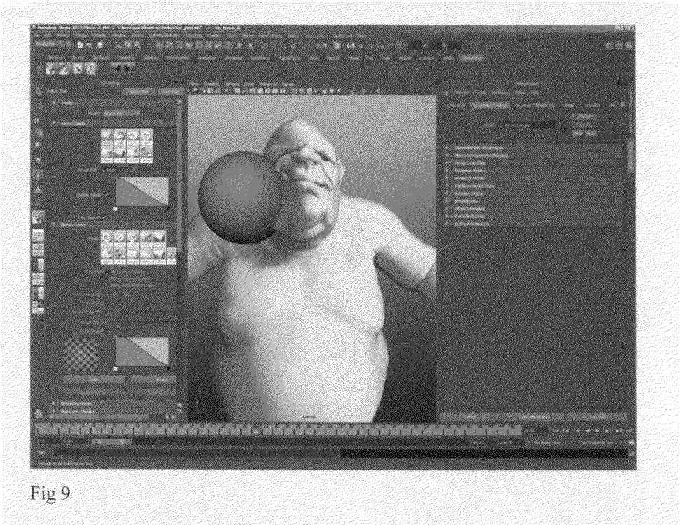

Our another improvement in the preferred embodiment is that we have created a set of corrective layers [FIG. 8]. You can also hand animate tweaks on top of the PSD corrections, this multilayered approach shatters all the walls between the artist and the final product. Letting the artist animate things like interactions between a finger and cheek on a rigged model. [FIG. 9]

We have also made some improvements to state of the art texture painting methods in this embodiment through use of a screenspace retesselation of the pixels under a brush and then redrawing that tesselation in UV space. The method lends itself nicely to accellerated drawing methods such as OpenGL or DirectX.

We have also come up with a kinematic joint method which allows one to apply physical simulations to joints to create a more believable animation. Typically animations are created on a skeleton of joints, where either rotations or positions are applied. Because there are a lot of things in motion, it is often quite challenging for an animator to satisfy needs of both the storyboard and the physical reality. It makes it very hard to give and maintain a sense of weight in the character. Previous attempts at applying this kind of simulation to characters has typically been a ‘ragdoll’ rig, which basically the body is viewed as a projectile and launched, everything that follows is a physical simulation. However, except for bodies flying through the air, it's not really what you want on an animated character, you want to animate it, and direct it's motion. Other simulations have included ones where the artist tells the character where to walk to and it uses algorithms and libraries of walk cycles to accomplish the task. However this is still not animation. The animator wants to do the pantomime and exaggerate pose where necessary. If you just apply physics to this, the animation is lost. Our idea was that you want to algorithmically determine which joints were most important to the artist and which are less important. Then apply a weighted simulation to the skeleton. The joint's goal is always the animated position, velocity gravity and other constraints are applied—the strength of the particular joint's ability to hit that animated position is guided by the weight. In our preferred embodiment, the weights are calculated by basically a bell curve against velocity. imagine the guy is standing and waving his arm, the body would be the slow part, the wrist the fast part. You want to apply more simulation to the elbow, and keep the wrist and shoulder pretty much on target. So you want the slow moving joints and the fast moving joints to be pinned down the most, and the in-between joints to be looser.

This can also clean up noisy motion capture data, other procedural gait methods, and walk cycles.

### DETAILED DESCRIPTION OF DRAWINGS

FIG. 1

Depicts an animated character inside a Autodesk's Maya (a popular animation program) with our tools in the margins and on the shelf. This is what the pose looks like without PSD applied. Notice the twisting issues in the shoulders and wrists.

FIG. 2

This figure depicts the animated character in FIG. 1 with PSD applied. Not the corrected tortion on the shoulder, the armpits and wrists. Notes the library of 7 poses in the right hand margin. The user has created these poses, sculpted corrections and stored them in this ‘cell’.

FIG. 3

This figure shows a sculpting cursor and sculpting tools in the margins.

FIG. 4

This figure shows approximately what the described cluster of points for the same joint in all of the various poses and the current point (marked current). This basically represents a characteristic the recognition bias weights should be based on (such as translation or rotation). A linear distance is calculated from the center to those points and a radial bias function is applied to bias closer points. While simple to implement, this method has a great deal of uncertainty as all points are considered.

FIG. 5

This figure shows a vornoi diagram superimposed on FIG. 4. This image shows that there are a number of ways to apply a distance bias, such as using a vornoi diagram to locate the nearest containing 3 points—then a barycentric weight can be calculated from them, thus minimising uncertainty further than a range bias function.

FIG. 6

This picture shows a list of joint sets (‘parts’) in the right hand margin—with outlines drawn over the character using the names of the corresponding parts to label them.

FIG. 7

This picture shows the painted weight values associated with the ‘upper right arm’ part.

FIG. 8

This image shows the parts list (outlined)

FIG. 9

This picture depicts Corrective Shape Animation mode. This mode does not build up a library, it is a method of keyframing sculpted tweaks. In this image a heavy ball is shown smushing his right cheek in. The smush is created using the high resolution sculpting tools and the deltas are stored as a key frame.

What is claimed is :

1. An improved method of angle driven Pose Space Deformation which includes the following integrated features :
a. A Multi-resolution Subdivision Surface Sculpting which makes use of various interactive tools and brushes
b. An editable pose library comprising both joints and surfaces
c. A mask system for partitioning the model
d. A Pose Space Deformation Engine to blend corrections from the pose library into partitioned subdivision geometry according to biased weights created by joint angles utilizing sparse interpolation strategies like radial bias functions and vornoi diagrams. Additional bias based on ‘importance’ is applied to increase accuracy.
e. A timeline in which the user can scrub animation and create sculpted additional corrective poses

2. An improved method of space driven Pose Space Deformation particularly suited to facial animation comprising:
a. A base application, such as Autodesk's Maya, which employs standard skin/skeleton articulation and animation.
b. An integrated Multi-resolution Subdivision Surface Sculpting environment which makes use of various interactive tools and brushes on top of the articulation in a.
c. An editable pose library comprising both joints and surfaces
d. A mask system for partitioning the model
e. A Pose Space Deformation Engine to blend corrections from the pose library into the partitioned subdivision geometry according to biased weights created by point configurations contained in library poses utilizing sparse interpolation strategies like radial bias functions and vornoi diagrams multiplied by painted weights for the associated ‘part’, and other motion based biases.
f. A timeline in which the user can scrub animation and create sculpted additional corrective poses

3. An interactive method for animating multi-resolution corrections to an animated surface using various sculpt brushes and tools comprising of the following work flow:
a) scrub the timeline and look at animated display for a problem area.
b) sculpt corrections using brushes and tools
c) keyframe the corrections into a motion track layer
d) iterate
With internals carrying out the following:
a) use tangent space as a way to express the vertex position as relative to the surface.
b) compress targets by only storing changes
c) interpolate animation in tangent space

4. An interactive method for creating and animating multi-resolution targets comprising the following work flow:
a) create and store animation targets (such as phonemes) using various sculpt brushes and tools
b) scrub the timeline and listen to the audio track and look at the animated display for cues
c) click on the target icons to keyframe
d) internally spline motion through all points and update
e) iterate

5. An animation layering dialogue which allows the user to additively combine and view layers of animation tweak tracks of various types in a stack containing features like:
a) on/off toggles
b) add/remove layer

6. An interface toggle which allows user to sculpt directly on an articulated/rigged and/or corrected model, or in a zero'd out rig so they can see the animation in claims 1-4 without with or without the mime.

7. An interface toggle for switching between tangent space and object space coordinates and a procedural method of converting the targets between the two.

8. An improved method for painting texture onto a multi resolution surface comprising the following steps:
a) Find bounds for the brush tool in pixel space
b) For each pixel within bound :
i. Cast a ray (or scan convert) and use barycentric math to calculate map uv values for pixel corners based on the low resolution triangle's screen coordinates.
ii. Calculate falloff weights and/or texture values for corners using barycentric coords
iii. Calculate any projection texture UVs for the pixel corners
iv. Draw textured polygon into the texture buffer using the map uv's as 2d draw coordinates for the (now nonsquare) pixel. whereas the texture in the polygon either contains the brush texture, or some kind of projection
c) Iterate with a variety of brushes such as blend, draw, erase, stencil, mask

9. An improved method for animating a “ragdoll” simulation comprising the following steps:
a) animate the skeleton's joints using standard techniques
b) compute importance weights for each joint (at every frame) using a curve applied to animated velocity.
c) apply a ragdoll simulation to the rig, but use these importance weights to constrain the joints position to the animated position.
d) Use the weighted constraints to apply rotational torque on the neighboring joint.
e) expose a user interface for the attenuation curve applied in step b.
f) expose interface for the ragdoll physics simulation like mass, gravity, viscosity, collision, or averaging such that the user can adjust parameters while the animation plays to see updated simulation results.
